(19) United States
(12) Patent Application Publication
(10) Pub. No.: US 2025/0185554 A1
(43) Pub. Date: Jun. 12, 2025

(54) APPARATUS AND METHOD FOR COLLECTING AND REMOVING BURRS

(71) Applicant: Sticker Picker, LLC, Stephenville, TX (US)

(72) Inventor: Marilyn S. Vice, Stephenville, TX (US)

(73) Assignee: Sticker Picker, LLC, Stephenville, TX (US)

(21) Appl. No.: 18/532,099

(22) Filed: Dec. 7, 2023

(51) Int. Cl. A01G 20/43; B08B 1/16; B08B 1/20

(52) U.S. Cl. CPC A01G 20/43; B08B 1/165; B08B 1/20

(57) ABSTRACT

An apparatus and method for picking up spiked objects from surfaces is presented. In embodiments, a device includes a frame configured to receive a propulsion force to move the device along a surface. The frame includes a roller mounting assembly, and a roller assembly is removably attached to the roller mounting assembly. The roller assembly is configured to rotate about a longitudinal axis. The roller assembly is configured to cause spiked objects disposed along the surface to attach to the roller assembly as the roller assembly rolls over the spiked objects. A scraper is configured to detach the spiked objects from the roller assembly as the spiked objects attached to the roller assembly contact the scraper due to the roller assembly rotating, and a collection tray is configured to capture the spiked objects detached from the roller assembly by the scraper.

### TECHNICAL FIELD

The present disclosure relates generally to environmental maintenance tools, and more particularly to devices configured for collection and/or removal of spiked objects from various surfaces.

### BACKGROUND

Stickers, also known as grass stickers, prickly thorns, goat heads, sticker burrs, sandburs, etc., are a widespread problem in many environments, ranging from agricultural fields to suburban lawns. These stickers, often originating from plants like burdock, cocklebur, and various species of thistles, are not only a nuisance but also pose several problems. For example, stickers can adhere to clothing, fur of animals, and even human skin, causing discomfort and potential injury. In agricultural settings, these stickers can contaminate crops, interfere with harvesting processes, and even harm livestock. In residential areas, stickers can render lawns and gardens unusable for recreational activities.

As big a problem as stickers may be, the primary method of dealing with stickers has traditionally been manual removal. This labor-intensive process involves individuals picking up these stickers by hand, which is not only time-consuming but also inefficient for large-scale removal. Furthermore, manual removal may pose a risk of injury to those performing the manual removal, as the stickers can be sharp and difficult to handle.

Some devices have been proposed for the removal of stickers. For example, one particular device uses a roller that is rotatable moved over the ground surface where the stickers may be. As the surface of the roller makes contact with the stickers, the stickers stick to the surface of the roller and are, in this manner, picked up from the ground. However, these devices do present some shortcomings.

For example, these existing devices may lack an efficient mechanism for clean-up and disposal of the stickers once the stickers have been picked up. Users of these devices may frequently face the challenge of manually clearing these devices of the collected burrs, which may reintroduce the problems of inefficiency and potential injury.

### SUMMARY

The present disclosure achieves technical advantages as a device for collecting spiked objects, and/or methods of manufacturing and/or using a device for collecting spiked objects, that includes functionality to efficiently collect spiked objects from ground and other surfaces and for easy cleanup and clearing of the collected spiked objects. Spiked objects can include grass stickers, prickly thorns, sticker burrs, goat heads, grassburs, sandburs, mesquite thorns, hackberry branches, and other weeds, vegetation, organic or inorganic objects having thorns or spikes. In particular embodiments, the spiked object collection device of embodiments may include a frame configured to provide structural support for the device and to receive a propulsion force to move the device along a surface. In embodiments, the frame may include a roller mounting assembly having a first end and a second end. The spiked object collection device of embodiments may include a roller assembly removably attached to the first end and second end of the roller mounting assembly and configured to rotate about a longitudinal axis. In embodiments, the roller assembly may be further configured to cause spiked objects disposed along the surface to attach or stick to the roller assembly as the roller assembly rolls over the spiked objects during the rotation of the roller assembly. The spiked object collection device of embodiments may include a scraper configured to detach the spiked objects from the roller assembly as the spiked objects attached to the roller assembly contact the scraper due to the roller assembly rotating, and a collection tray configured to capture the spiked objects detached from the roller assembly by the scraper.

As such, spiked object collection devices implemented in accordance with embodiments of the present disclosure may not only provide an efficient mechanism for collecting and removing spiked objects from surfaces, but may also provide a mechanism for easy cleaning or clearing of the devices of the collected spiked objects, and in this manner, may prevent the inefficiencies and/or potential injuries associated with current devices.

It is an object of the disclosure to provide a device for collecting spiked objects from surfaces. It is a further object of the disclosure to provide a method of manufacturing a device for collecting spiked objects from surfaces. It is still a further object of the disclosure to provide a method of using a device for collecting spiked objects from surfaces.

In one particular embodiment, a device for collecting spiked objects from surfaces is provided. The device includes a frame configured to provide structural support for the device and to receive a propulsion force to move the device along a surface. In embodiments, the frame includes a roller mounting assembly having a first end and a second end. The device further includes a roller assembly removably attached to the first end and second end of the roller mounting assembly and configured to rotate about a longitudinal axis. In embodiments, the roller assembly is further configured to cause spiked objects disposed along the surface to attach to the roller assembly as the roller assembly rolls over the spiked objects during the rotation of the roller assembly. In embodiments, the device also includes a scraper configured to detach the spiked objects from the roller assembly as the spiked objects attached to the roller assembly contact the scraper due to the roller assembly rotating, and a collection tray configured to capture the spiked objects detached from the roller assembly by the scraper.

In another embodiment, a method of manufacturing a device for collecting spiked objects from surfaces is provided. The method includes forming a frame to provide structural support for the device and to receive a propulsion force to move the device along a surface, disposing a roller mounting assembly having a first end and a second end onto the frame, and removably attaching a roller assembly to the first end and second end of the roller mounting assembly. In embodiments, the roller assembly is configured to rotate about a longitudinal axis, and to cause spiked objects disposed along the surface to attach to the roller assembly as the roller assembly rolls over the spiked objects during the rotation of the roller assembly. The method further includes mounting a scraper to detach the spiked objects from the roller assembly as the spiked objects attached to the roller assembly contact the scraper due to the roller assembly rotating and positioning a collection tray to capture the spiked objects detached from the roller assembly by the scraper.

In yet another embodiment, a method of collecting spiked objects from surfaces using a spiked object collection device is provided. The method includes positioning a collection device over the surface such that a roller assembly of the collection device is in contact with the surface. In embodiments, the roller assembly may be configured to rotate about a longitudinal axis over the surface. The method further includes applying a propulsion force against a frame of the collection device. In embodiments, applying the propulsion force against the frame of the collection device causes the roller assembly to rotate about the longitudinal axis and to roll over the surface. The method also includes collecting spiked objects disposed along the surface. In embodiments, collecting the spiked objects disposed along the surface includes causing the spiked objects disposed along the surface to attach to the roller assembly as the roller assembly rolls over the spiked objects during the rotation of the roller assembly, detaching the spiked objects from the roller assembly as the spiked objects attached to the roller assembly contact the scraper due to the roller assembly rotating, and receiving the spiked objects detached from the roller assembly by the scraper into a collection tray.

The foregoing has outlined rather broadly the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following descriptions taken in conjunction with the accompanying drawings, in which:

FIG. 1 shows an exemplary spiked object collection device configured with capabilities and functionality for collecting spiked objects from ground surfaces and for clearing of the collected spiked objects from the spiked object collection device in accordance with embodiments of the present disclosure.

FIGS. 2A and 2B illustrate an exemplary configuration of a roller mounting assembly to facilitate removal of a sleeve of a roller assembly in accordance with embodiments of the present disclosure.

FIG. 3 illustrates an example of a roller assembly configured in accordance with embodiments of the present disclosure.

FIG. 4 shows a side view of an exemplary spiked object collection device during operation for collecting spiked objects from ground surfaces and for clearing of the collected spiked objects from the spiked object collection device in accordance with embodiments of the present disclosure.

FIG. 5 illustrates an exemplary configuration of a spiked object collection device to be propelled by a person in accordance with embodiments of the present disclosure.

FIGS. 6A and 6B illustrates an exemplary configuration of a spiked object collection device to be propelled by a vehicle in accordance with embodiments of the present disclosure.

FIG. 7 shows a high-level flow diagram of operation of a device for collecting spiked objects from surfaces in accordance with embodiments of the present disclosure for preventing accumulation of precipitation over an imaging sensor.

FIG. 8 shows an exemplary flow diagram of operations for manufacturing a device configured with functionality to collect spiked objects from surfaces in accordance with aspects of the present disclosure.

It should be understood that the drawings are not necessarily to scale and that the disclosed embodiments are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular embodiments illustrated herein.

### DETAILED DESCRIPTION

The disclosure presented in the following written description and the various features and advantageous details thereof, are explained more fully with reference to the non-limiting examples included in the accompanying drawings and as detailed in the description. Descriptions of well-known components have been omitted to not unnecessarily obscure the principal features described herein. The examples used in the following description are intended to facilitate an understanding of the ways in which the disclosure can be implemented and practiced. A person of ordinary skill in the art would read this disclosure to mean that any suitable combination of the functionality or exemplary embodiments below could be combined to achieve the subject matter claimed. The disclosure includes either a representative number of species falling within the scope of the genus or structural features common to the members of the genus so that one of ordinary skill in the art can recognize the members of the genus. Accordingly, these examples should not be construed as limiting scope of the claims.

A person of ordinary skill in the art would understand that any system claims presented herein encompass all of the elements and limitations disclosed therein, and as such, require that each system claim be viewed as a whole. Any reasonably foreseeable items functionally related to the claims are also relevant. The Examiner, after having obtained a thorough understanding of the disclosure and claims of the present application has searched the prior art as disclosed in patents and other published documents, i.e., nonpatent literature. Therefore, as evidenced by issuance of this patent, the prior art fails to disclose or teach the elements and limitations presented in the claims as enabled by the specification and drawings, such that the presented claims are patentable under the applicable laws and rules of this jurisdiction.

Various embodiments of the present disclosure are directed to a device for collecting spiked objects, and/or methods of manufacturing and/or using a device for collecting spiked objects, that includes functionality to efficiently collect spiked objects from ground surfaces and for easy cleanup and clearing of the collected spiked objects. In particular embodiments, the spiked object collection device of embodiments may include a frame configured to provide structural support for the device and to receive a propulsion force to move the device along a surface. In embodiments, the frame may include a roller mounting assembly having a first end and a second end. The spiked object collection device of embodiments may include a roller assembly removably attached to the first end and second end of the roller mounting assembly and configured to rotate about a longitudinal axis. In embodiments, the roller assembly may be further configured to cause spiked objects disposed along the surface to attach or stick to the roller assembly as the roller assembly rolls over the spiked objects during the rotation of the roller assembly. The spiked object collection device of embodiments may include a scraper configured to detach the spiked objects from the roller assembly as the spiked objects attached to the roller assembly contact the scraper due to the roller assembly rotating, and a collection tray configured to capture the spiked objects detached from the roller assembly by the scraper.

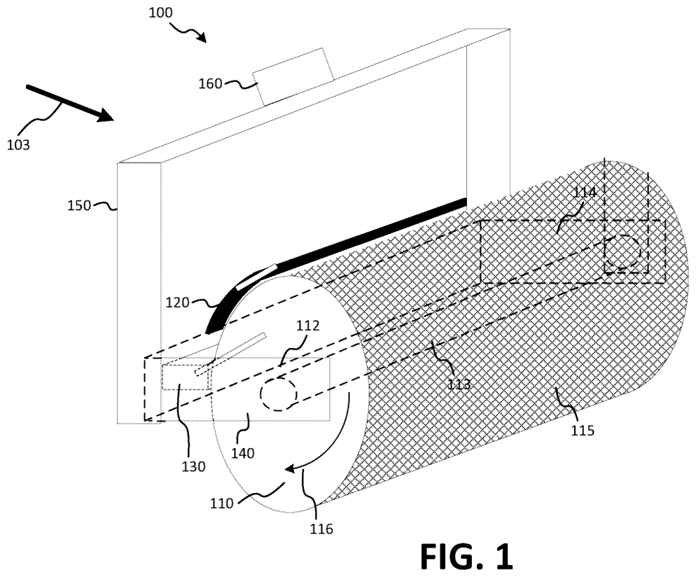

FIG. 1 shows an exemplary spiked object collection device 100 configured with capabilities and functionality for collecting spiked objects from ground surfaces and for clearing of the collected spiked objects from the spiked object collection device in accordance with embodiments of the present disclosure. As shown in FIG. 1, spiked object collection device 100 include frame 150, roller assembly 110, scraper 120, and collection tray 130, and these components may be configured to include various components and/or configurations for providing functionality as described in various embodiments of the present disclosure.

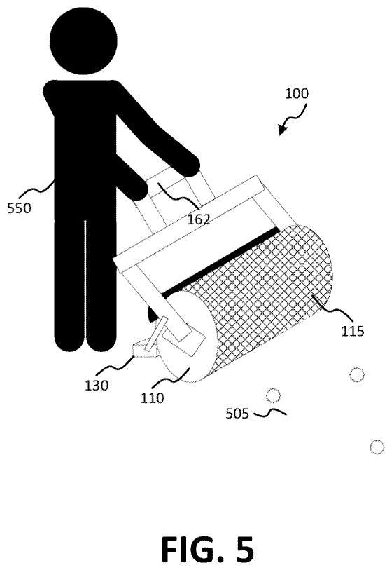

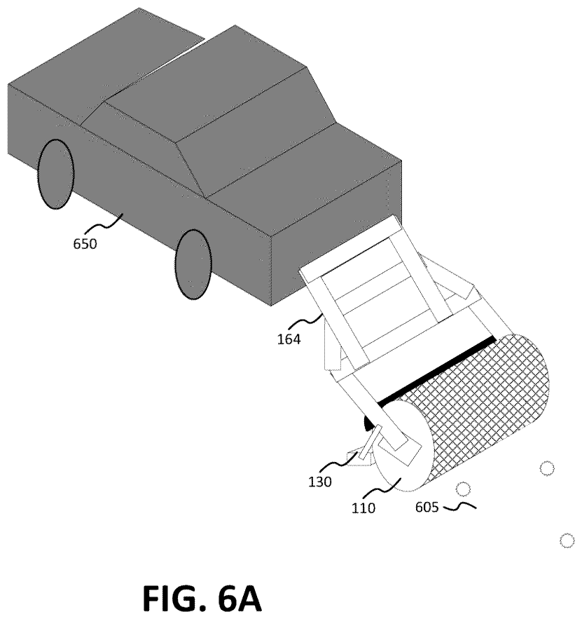

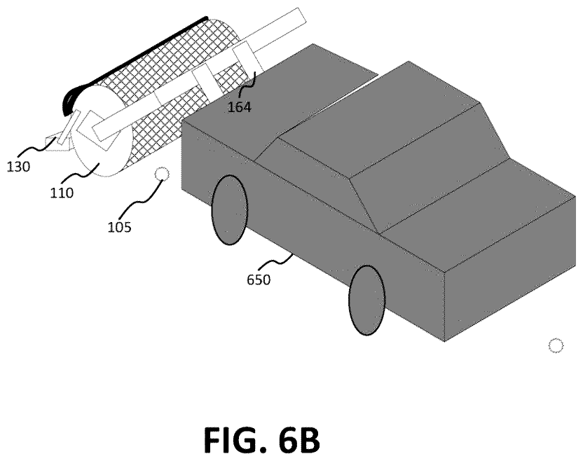

Frame 150 may be configured to provide structural support for spiked object collection device 100. For example, frame 150 may be made of strong materials (e.g., steel, aluminum, etc.) and may provide a structure for mounting various components of spiked object collection device 100. For example, frame 150 may include connector 160 configured to attach frame 150 to a propulsion source. In embodiments, the propulsion source may be configured to provide a power to move spiked object collection device 100 over the surface over which spiked object collection device 100 is to operate. In embodiments, as will be discussed in more detail below with reference to FIGS. 5, 6A, and 6B, spiked object collection device 100 may be used in different applications and/or environments. For example, spiked object collection device 100 may be used in heavy-duty application (e.g., industrial applications, large scale applications, etc.), which may include applications in which spiked object collection device 100 may be attached to a vehicle (e.g., a truck, tractor, trailer, etc.) to be pushed or pulled during operations. In this case, connector 160 may be configured to attach frame 150 to the vehicle. Light-duty application (e.g., non-industrial applications, residential applications etc.) may include applications in which spiked object collection device 100 may be pushed or pulled manually by a person. In this case, connector 160 may be configured to enable the person to push or pull spiked object collection device 100, such as by including a handle.

In embodiments, frame 150 may be configured to include and/or support roller mounting assembly 140. Roller mounting assembly 140 may be configured to enable roller assembly 110 to be removably attached to frame 150. In particular, roller mounting assembly 140 may be configured to enable roller assembly 110 to be removably attached to first end 112 and second end 114 of roller mounting assembly 140.

Roller mounting assembly 140 may be configured to allow roller assembly 110 to rotate about a longitudinal axis of roller assembly 110. For example, roller mounting assembly 140 may include, at each of first end 112 and second end 114, a bearing configured to receive a respective end of an axle 113 of roller assembly 110. The coupling between the bearings and the corresponding ends of axle 113 may allow roller assembly to rotate about its longitudinal axis with respect to roller mounting assembly 140, while roller mounting assembly 140 may remain stationarily coupled to frame 150. For example, a force applied against spiked object collection device 100 in direction 117 (e.g., applied against connector 160) may cause roller assembly to rotate in direction 116, causing spiked object collection device 100 to move in direction 103. In this case, the outer surface 115 of roller assembly 110, which may be configured to contact the surface over which spiked object collection device 100 is operating (e.g., a ground surface), may be in rotating engagement with the surface as spiked object collection device 100 moves along the surface.

It is noted that in some embodiments, axle 113 may traverse the entire length of roller assembly 110 or may not traverse the interior length of roller assembly 110 and may instead include shafts that protrude from each end of roller assembly 110 and attach (e.g., rotatably attach) to each corresponding end of roller mounting assembly 140.

In embodiments, roller mounting assembly 140 may have a particular configuration to enable roller assembly 110 to be removably attached to first end 112 and second end 114 of roller mounting assembly 140. For example, in some embodiments, roller mounting assembly 140 may receive, at each of first end 112 and second end 114, a corresponding end of roller assembly 110 and may secure each end using any fastening or attachment mechanism (e.g., screws, bolts, latch, etc.) such that each end of roller assembly 110 may be allowed to rotate about the longitudinal axis of roller assembly 110 while being secured within a corresponding one of first end 112 and second end 114 of roller mounting assembly 140. The fastening or attachment mechanism may be operated to enable roller assembly 110 to be removed from roller mounting assembly 140. For example, the latch may be opened, the screws or bolts removed, etc., to enable roller assembly 110 to be removed from one or more of first end 112 and second end 114 of roller mounting assembly 140.

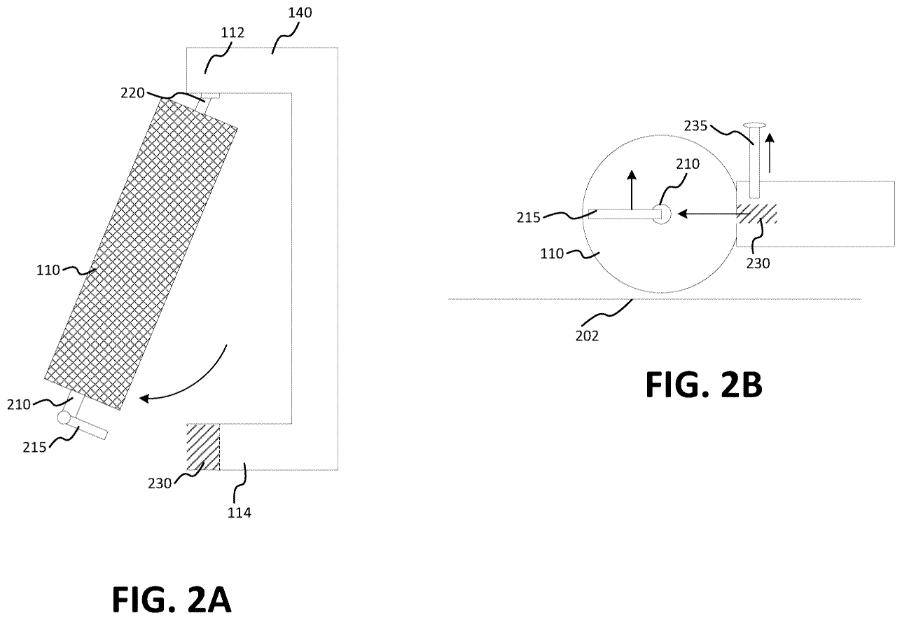

In a particular embodiment, roller mounting assembly 140 may be configured to enable one end of roller assembly 110 to be swung out of roller mounting assembly 140 while the other end of roller assembly 110 may stay engaged with roller mounting assembly 140. This particular configuration may enable or facilitate easy removal of a sleeve of roller assembly 110 (e.g., as discussed in more detail below) from roller assembly 110. FIGS. 2A and 2B illustrate an exemplary configuration of roller mounting assembly 140 to facilitate removal of a sleeve of roller assembly 110 in accordance with embodiments of the present disclosure.

As shown in FIG. 2A, roller mounting assembly 140 may be configured to allow one end of roller assembly 110 (e.g., the end of roller assembly removably coupled to second end 114) to swing out of roller mounting assembly 140 while allowing the other end of roller assembly 110 (e.g., the end of roller assembly removably coupled to first end 112) to remain engaged with roller mounting assembly 140. In this manner, a user may obtain access to roller assembly 110 (e.g., to remove and/or replace the sleeve of roller assembly 110) while maintaining engagement with roller mounting assembly 140.

In embodiments, the configuration of roller mounting assembly 140 to allow a first end of roller assembly 110 to swing out of roller mounting assembly 140 while allowing the second end of roller assembly 110 to remain engaged with roller mounting assembly 140 may include configuration of roller mounting assembly 140 to include hinge 220 and latch 230. In embodiments, the first end of roller assembly 110 may be attached to first end 112 of roller mounting assembly 140 using hinge 220. Hinge 220 may allow roller assembly 110 to pivot about hinge 220, while maintaining the first end of roller assembly 110 engaged with roller mounting assembly 140.

In embodiments, second end 114 of roller assembly 140 may include latch 230, which may be configured to receive shaft 210, attached to the second end of roller assembly 110. Latch 230 may be configured to, in a first configuration, secure shaft 210 to latch 230, such that shaft 210 remains within latch 230 and may not escape latch 230. In embodiments, a pin, screw, bolt, etc., may be used to secure shaft 210 to latch 230. For example, as shown in FIG. 2B, fastener 235 may be used to secure shaft 210 within latch 230.

Latch 230 may be configured to, in a second configuration, allow shaft 210 to be removed from latch 230. For example, as shown in FIG. 2B, fastener 235 may be removed or disengaged from latch 230, allowing shaft 210 to be removed from latch 230. In this second configuration, during operation, shaft 210 may be removed from latch 230, which may allow roller assembly 110 to be separated, at the second end, from second end 114, while pivoting about first end 112 (e.g., at hinge 220), enabling the second end of roller assembly 110 to be swung out of roller mounting assembly 140 while mainlining the first end of roller assembly 110 engaged with first end 114 roller mounting assembly 140. In this position, the sleeve of roller assembly 110 may be easily removed and/or replaced from roller assembly 110.

In embodiments, roller assembly 110 may include lever 215 configured to facilitate removal of roller assembly 110 from roller mounting assembly 140 and/or lifting of roller assembly 110 to a raised position. For example, lever 215 may be disposed at the second end of roller assembly 110. In embodiments, lever 215 may provide a mechanism to, after fastener 235 is removed or disengaged from latch 230, apply a force (e.g., by a user) to swing the second end of roller assembly 110 out of roller mounting assembly 140. In this manner, lever 215 may operate as a handle for the user.

In embodiments, lever 215 may operate to provide a mechanism for lifting roller assembly 110 off surface 202. For example, after the second end of roller assembly 110 is swung out of roller mounting assembly 140, the weight of roller assembly 110 may cause roller assembly 110 to fall upon surface 202. Due to the weight of roller assembly 110, removing and/or replacing the sleeve of roller assembly 110 may prove difficult. Lever 215 may provide a mechanism to lift roller assembly 110 off surface 202, which may facilitate removal and/or replacement of the sleeve of roller assembly 110.

In embodiments, hinge 220 may further operate to as a point of leverage for lifting roller assembly 110 off surface 202. For example, as hinge 220 is disposed at the opposite end of roller assembly 110 (e.g., opposite end to the end of roller assembly 110 at which lever 215 is disposed), hinge 220 may create a fulcrum point against which the lifting force applied at lever 215 can be applied. In this manner, a user may more easily lift roller assembly 110 off surface 202 to remove and/or replace the sleeve of roller assembly 110.

In some embodiments, a holding mechanism (not shown) may be included at first end 112 of roller mounting assembly 140 that may enable the raised position of roller assembly 110 (e.g., the position of roller assembly 110 off surface 202) to be maintained. For example, once a user lifts roller assembly 110 (e.g., using lever 215) off surface 202 the holding mechanism may be engaged to keep roller assembly 110 off surface 202 even when the user stops lifting roller assembly 110. In embodiments, the holding mechanism may include a pin that is positioned such that roller assembly 110 may rest upon the point and is configured to maintain roller assembly 110 in the raised position. In some embodiments, hinge 220 may include the holding mechanism.

With reference back to FIG. 1, roller assembly 110 may be configured to engage against the surface (e.g., the surface upon which the spiked objects are laid out or disposed) to collect the spiked objects. In particular embodiments, roller assembly 110 may be configured to roll along the surface while in contact with the surface and to cause spiked objects disposed along the surface to attach or stick to outer surface 115 of roller assembly 110. In this manner, roller assembly 110 may roll over and collect the spiked objects.

In embodiments, roller assembly 110 may be configured as a cylindrical shaped drum having an outer surface 115 configured to cause spiked objects to attach to outer surface 115. In some embodiments, outer surface 115 may be made of a suitable material to cause spiked objects to stick to the material. For example, outer surface 115 may be made of a fabric material, or any other fiber material that may have an affinity to attach spiked objects.

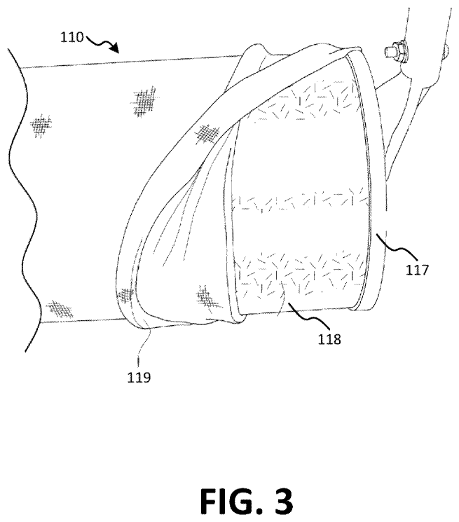

In embodiments, roller assembly 110 may include various components configured to provide functionality in accordance with embodiments herein. FIG. 3 illustrates an example of a roller assembly 110 configured in accordance with embodiments of the present disclosure. As shown in FIG. 3, roller assembly 110 may include cylindrical drum 117 and sleeve 119. In embodiments, roller assembly 110 may comprise sleeve 119 removably mounted over cylindrical drum 117. In embodiments, sleeve 119 may be made of stretchable material, such as stretchable fabric material. In some embodiments, the stretchable material may include cotton or other fibrous material that may have an affinity to allow spiked objects to attach to the fibrous material. In some embodiments, sleeve 119 may be biodegradable. Sleeve 119 may be slid over cylindrical drum 117 and may include fasteners to ensure that sleeve 119 remains secured against cylindrical drum 117. In embodiments, a Velcro-like material, drawstrings, snaps, ties, etc., may be used to secure sleeve 119 against cylindrical drum 117. For example, drawstrings may be used at each end of sleeve 119 to secure each end of sleeve 119 against a corresponding end of cylindrical drum 117. In embodiments, sleeve 119 may be removable from cylindrical drum 117 may sliding sleeve 119 off cylindrical drum 117. In embodiments, removably mounting sleeve 119 onto cylindrical drum 117 may allow sleeve 119 to be replaced (e.g., when sleeve 119 is so worn out that it is no longer able to pick up a significant number of spiked objects, or when sleeve 119 has attached so many spiked objects that sleeve 119 is too full and/or no longer able to pick up more spiked objects).

In embodiments, a middle layer 118 may be disposed between cylindrical drum 117 and sleeve 119. Middle layer 118 may include a soft material configured to provide compliance as roller assembly 110 rolls over the spiked objects to facilitate the spiked objects attaching to sleeve 119. In this case, the softness of middle layer 118 may help ensure that the point of contact between sleeve 119 and a spiked object includes a larger surface area than without the soft material of middle layer 118.

Cylindrical drum 117 of roller assembly 110 may be configured to have a cylindrical shape to facilitate rolling over the surface and may be made or formed from a suitable material, such as plastic, metal, fiberglass, carbon fiber, etc. In embodiments, the length of the cylindrical drum (and consequently of roller assembly 110) may depend or be based on the application in which spiked object collection device 100 is to be used. For example, for some larger-scale applications (e.g., operations of spiked object collection device 100 for collecting spiked objects on agricultural settings, or larger areas), a longer cylindrical drum may be used than for low-duty applications (e.g., operations of spiked object collection device 100 for collecting spiked objects on residential areas, smaller areas, etc.). In some embodiments, cylindrical drum 117 may be constructed using a unitary construction, or may be modular, in which case multiple cylindrical drums may be attached together to form a single cylindrical drum 117. This latter approach may enable the size of cylindrical drum 117 to vary and be configured according to operational requirements.

In embodiments, cylindrical drum 117 may be formed as a hollow drum to save weight, and to make spiked object collection device 100 lighter for applications in which a lighter spiked object collection device 100 may be more suitable. For example, for residential applications, and/or for applications in which the spiked object collection device 100 may be propelled manually by a user (e.g., a person), a lighter cylindrical drum 117 may result in a lighter spiked object collection device 100, which may be beneficial in these applications to prevent the user from over-tiring.

In other embodiments, cylindrical drum 117 may be formed as a solid drum. A solid drum may result in a heavier cylindrical drum 117 (e.g., heavier than a hollow drum). A heavier cylindrical drum 117 may be suitable for applications in which spiked object collection device 100 may be propelled using a power device (e.g., a vehicle or other powered devices), in which a heavier cylindrical drum 117 may facilitate or be beneficial to the contact between roller assembly 110 and the surface over which spiked object collection device 100 may operate. For example, in some cases, the surface may include a grassy area, in which the grass may have a significant height. In this case, a heavier roller assembly 110 may be more beneficial, as a heavier roller assembly 110 may be able to apply more pressure or push against the tall grass to reach spiked objects buried under the tall grass and pick them up on sleeve 119.

In some embodiments, the weight of cylindrical drum 117, and consequently the weight of roller assembly 110, may be configurable. For example, in some embodiments, the weight of the cylindrical drum 117 may be changed or configured based on the application. In some applications, such as when spiked object collection device 100 is to operate over a surface with short grass, a lighter cylindrical drum 117 may be used, whereas in other applications, such as when spiked object collection device 100 is to operate over a surface with tall grass, a heavier cylindrical drum 117 may be used.

In embodiments, varying the weight of cylindrical drum 117 may include various techniques. In a particular embodiment, cylindrical drum 117 may include a hollow drum. In this case, varying the weight of cylindrical drum 117 may include adding and/or removing material from the interior of cylindrical drum 117. The material may include sand, water, rocks, etc.

In another embodiment, cylindrical drum 117 may include a removable weighted axle. For example, as shown in FIG. 1, roller assembly 110 may include an axle 113. Axle 113 may be weighted, and the weight of axle 113 may be based on the application in which spiked object collection device 100 is to be used. In this embodiment, various axles of different weights may be available and an axle with a particular weight may be selected to be used within roller assembly 110, where the particular axle of the particular weight is selected based on the application. For example, in some applications, such as when spiked object collection device 100 is to operate over a surface with short grass, a first axle with a lighter weight may be used within roller assembly 110 may be used, whereas in other applications, such as when spiked object collection device 100 is to operate over a surface with tall grass, second axle with a heavier weight may be used within roller assembly 110. In this manner, the weight of axle 113 may be selected based on the application in which spiked object collection device 100 is to be used.

In embodiments, the configuration of roller assembly 110 to roll over a surface may include configuration of roller assembly 110 to removably attach to roller mounting assembly 140 such that roller assembly 110 is secured within roller mounting assembly 140 while being allowed to rotate about a longitudinal axis of roller assembly 110. Roller assembly 110 may also be configured to contact the surface over which sticker collection device 100 is to operate.

In embodiments, scraper 120 may be configured to detach or separate spiked objects from outer surface 115. For example, as roller assembly 110 rotates, the rotation of roller assembly 110 may cause spiked objects attached to outer surface 115 to contact scraper 120. In this case, scraper 120 may scrape or otherwise cause the spiked objects to be separated or detach from outer surface 115. In this manner, scraper 120 may operate to scrape spiked objects off outer surface 115 of roller assembly 110.

In embodiments, scraper 120 may be removably attached to frame 150, such as using fastener 121. Fastener 121 may include a bolt, screw, pin, latch, quick-release connector, or any other type of fastener configured to secure scraper 120 to frame 150. In these embodiments, scraper 120 may be removed from frame 150 by disengaging fastener 121.

In embodiments, collection tray 130 may be configured to capture or collect spiked objects scraped off outer surface 115 of roller assembly 110 by scraper 120. For example, as spiked objects are separated or detached from outer surface 115 by scraper 120, the separated spiked objects may fall (e.g., due to gravity) onto collection tray 130. In this manner, collection tray 130 may collect or capture stickers scraped off outer surface 115 by scraper 120.

In embodiments, the distance between scraper 120 and outer surface 115 may be configured to scrape bigger-sized stickers (e.g., goat head burrs) off outer surface 115 while allowing smaller-sized spiked objects to pass through the distance without being scraped off outer surface 115. For example, smaller-sized spiked objects may tend to become so entangled to outer surface 115 that scraping off these smaller-sized spiked objects may be difficult or impossible without causing damage to outer surface 115. However, larger-sized spiked objects, such as goat head burrs, may not become so entangled and may be scraped off outer surface 115 more easily. In this manner, by configuring the distance between scraper 120 and outer surface 115 to allow smaller-sized spiked objects to pass through while preventing larger-sized spiked objects from passing through, relative cleanup of outer surface 115 may be accomplished by scraper 120 while preventing potential damage to outer surface 115.

In embodiments, collection tray 130 may be removably attached to frame 150, such as using fastener 131. Fastener 131 may include a bolt, screw, pin, latch, quick-release connector, or any other type of fastener configured to secure collection tray 130 to frame 150. In these embodiments, collection tray 130 may be removed from frame 150 by disengaging fastener 131. In embodiments, collection tray 130 may be mounted onto frame 150, or may be mounted (e.g., attached) to scraper 120. In embodiments, collection tray 130 may be removable to enable an operator to remove collection tray 130 and empty collection tray 130.

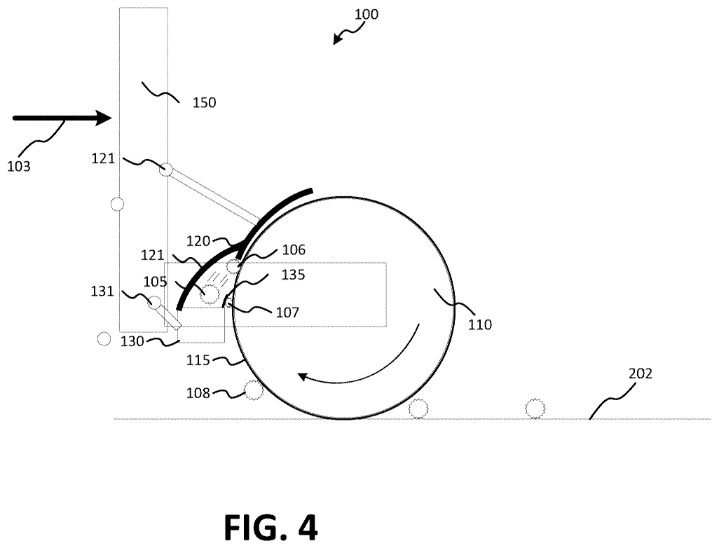

Operation of spiked object collection device 100 will now be discussed with respect to FIG. 4 in accordance with aspects of the present disclosure. FIG. 4 shows a side view of exemplary spiked object collection device 100 during operation for collecting spiked objects from ground surfaces and for clearing of the collected spiked objects from the spiked object collection device in accordance with embodiments of the present disclosure. As shown in FIG. 4, spiked object collection device 100 may be configured to operate over surface 202, over which a plurality of spiked objects may be disposed or laid out. In embodiments, surface 202 may represent a ground surface, a grassy surface, or any other surface over which spiked objects may be present.

During operation, spiked object collection device 100 may be positioned over surface 202, such that outer surface 115 of roller assembly 110 engages or makes contact with surface 202. A propulsion force 103 may be applied against spiked object collection device 100, and in particular against frame 150 of spiked object collection device 100. For example, propulsion force 103 may be received from a person or from a vehicle (e.g., based on the application and/or configuration of spiked object collection device 100). The different configurations of spiked object collection device 100 will now be discussed with respect to FIGS. 5, 6A, and 6B.

FIG. 5 illustrates an exemplary configuration of a spiked object collection device 100 to be propelled by a person in accordance with embodiments of the present disclosure. In particular, in this manual configuration, spiked object collection device 100 may be configured with a lighter roller assembly 110 (e.g., lighter than the roller assembly of a powered configuration). In this manual configuration, the size of spiked object collection device 100 may also be smaller than the size of the spiked object collection device for a powered configuration. Furthermore, the configuration of frame 150, and in particular the configuration of connector 160 may be based on the manual configuration.

For example, as shown, connector 160 may include handle 162, which may be configured to enable user 550 to push or pull spiked object collection device 100 over the surface. In this example, the propulsion force may be provided by user 550. As user 550 pushes (or pulls) spiked object collection device 100 over the surface, roller assembly 110 may roll over spiked objects 505, and may operate to collect the spiked objects in accordance with embodiments described herein.

FIGS. 6A and 6B illustrates an exemplary configuration of a spiked object collection device 100 to be propelled by a vehicle in accordance with embodiments of the present disclosure. In particular, in this powered configuration, spiked object collection device 100 may be installed onto a vehicle such that spiked object collection device 100 may lead or be pushed (e.g., as shown in FIG. 6A) by vehicle 650 (e.g., a truck, tractor, trailer, forklift, lawnmower, autonomous vehicle, autonomous lawnmower, etc.), or may follow or be pulled (e.g., as shown in FIG. 6B) by vehicle 650.

In embodiments, in the powered configuration, spiked object collection device 100 may be configured with a heavier roller assembly 110 (e.g., heavier than the roller assembly of a manual configuration). In this powered configuration, the size of spiked object collection device 100 may also be larger than the size of the spiked object collection device for a manual configuration.

In embodiments, the configuration of frame 150, and in particular the configuration of connector 160, may be based on the powered configuration. For example, as shown in FIG. 6A, connector 160 may include vehicle connector 164, which may be configured to removably attach spiked object collection device 100 to vehicle 650, to enable vehicle 650 to push (or pull as shown in FIG. 6B) spiked object collection device 100 over the surface. In some embodiments, such as in embodiments in which spiked object collection device 100 is to be attached to a tractor or trailer, vehicle connector 164 may be configured as a three-point hitch enabling spiked object collection device 100 to be attached to the tractor or trailer. In some cases, this configuration may also enable roller assembly 110 to be raised (e.g., by the tractor, trailer, or forklift) so that an operator may remove and/or replace the sleeve from the roller assembly 110.

In this example, the propulsion force may be provided by vehicle 650. As vehicle 650 pushes (or pulls) spiked object collection device 100 over the surface, roller assembly 110 may roll over spiked objects 605, and may operate to collect the spiked objects in accordance with embodiments described herein.

With reference back to FIG. 4, as propulsion force 103 is applied against spiked object collection device 100, propulsion force 103 may cause roller assembly 110 to rotate about its longitudinal axis and to roll along surface 202. In particular, outer surface 115 of roller assembly 110 may roll in rotatable engagement over surface 202.

As roller assembly 110 rolls over surface 202, outer surface 1154 may roll over the spiked objects disposed along surface 202, causing the spiked objects to stick or attach to outer surface 115. For example, spiked object 108 may be attached or stuck to outer surface 115. Similarly, spiked objects 106 and 107 may currently be stuck or attached to outer surface 115, after roller assembly 110 has rolled over these spiked objects. In this manner, these spiked objects that have stuck or attached to outer surface 115 of roller assembly 110 have been picked up from surface 202 and are no longer laid out over surface 202, no longer lurking on surface 202 and no longer capable of causing injury to someone. As roller assembly 110 continues to roll over surface 202, other spiked objects still on surface 202 may be similarly picked up.

In some embodiments, such as in embodiments in which spiked object collection device 100 may include scraper 120 and collection tray 130, as roller assembly 110 continues to rotate (e.g., in the clockwise direction), spiked objects attached to outer surface 115 may be pushed against scraper 120. For example, spiked object 106 may currently be in contact with scraper 120, and spiked objects 107 and 108 may eventually come into contact with scraper 120 if roller assembly 110 continues to rotate. In this example, due to the rotation of roller assembly 110, spiked object 106 may be scraped off or separated from outer surface 115. For example, scraper 120 may be in contact with outer surface 115, or may be separate from outer surface 115 by a small distance, such that no spiked object may be able to pass between scraper 120 and outer surface 115, and consequently may be separated from outer surface 115. For example, spiked object 105 may have been separate from outer surface 115 and spiked object 106 may be currently being separated from outer surface 115.

In embodiments, spiked objects separated from outer surface 115 may be caught or collected by collection tray 130. For example, as shown, collection tray 130 may be mounted behind roller assembly 110 and positioned such that, as spiked objects are detached or separated from outer surface 115, the separated spiked objects fall into collection tray 130. In this manner, outer surface 115 may be kept clean and clear of spiked objects, maximizing the service time of outer surface 115 (e.g., maximizing the time-in-service of the sleeve of roller assembly 110, which minimizes having to replace the sleeve).

In some embodiments, a flexible plug 135 may be disposed between collection tray 130 and outer surface 115 to allow attached spiked objects to pass through in one direction (e.g., in the clockwise direction) but prevent detached spiked objects from falling through the space between collection tray 130 and outer surface 115. For example, spiked object 107 may currently be passing through the space between collection tray 130 and outer surface 115, and flexible plug 135 may allow spiked object 107 to pass through the space between collection tray 130 and outer surface 115. However, after spiked object 107 has passed through the space between collection tray 130 and outer surface 115, flexible plug 135 may cover the space such as to prevent detached spiked objects (e.g., detached spiked object 105) to fall through the space.

In embodiments, shield 121 may operate to prevent spiked objects detached from outer surface 115 (e.g., by the scraping action of scraper 120) from falling outside of collection tray 130. For example, shield 121 may be configured and/or disposed to enclose or cover the are between scraper 120 and collection tray 130, such that spiked objects detached from outer surface 115 may hit against shield 121 and be prevented from falling outside collection tray 130. In embodiments, shield 121 may be mounted onto scraper 120 and onto collection tray 130. In some embodiments, shield 121 may also operate to mount collection tray 130 to scraper 120, such that fastener 131 may be eliminated.

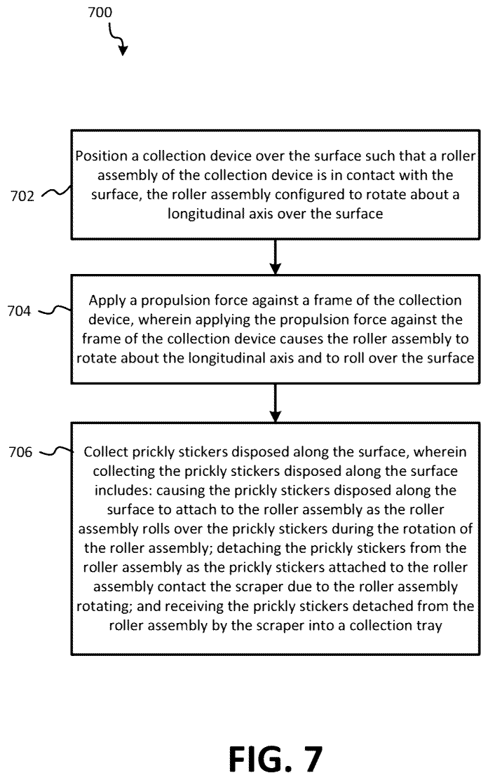

FIG. 7 shows a high-level flow diagram of operation for collecting spiked objects from a surface in accordance with embodiments of the present disclosure. For example, the functions illustrated in the example blocks shown in FIG. 7 may be performed using spiked object collection device 100 of FIG. 1 according to embodiments herein.

At block 702, a collection device is positioned over a surface such that a roller assembly of the collection device is in contact with the surface. In embodiments, the roller assembly may be configured to rotate about a longitudinal axis over the surface. In embodiments, the collection device may include a spiked object collection device (e.g., spiked object collection device 100 of FIG. 1). In embodiments, the spiked object collection device may include functionality and may perform operations according to operations and functionality as described above with reference to spiked object collection device 100, and as illustrated in FIGS. 1-6B.

At block 704, a propulsion force is applied against a frame of the collection device. In embodiments, applying the propulsion force against the frame of the collection device may cause the roller assembly to rotate about the longitudinal axis and to roll over the surface. In embodiments, the propulsion force may include a propulsion force (e.g., propulsion force 103 of FIGS. 1 and 4). In embodiments, the propulsion force may represent a propulsion force provided by a vehicle or a person to move the device along the surface according to operations and functionality as described above with reference to FIGS. 1-6B.

At block 706, spiked objects disposed along the surface are collected. In embodiments, collecting the spiked objects disposed along the surface may include causing the spiked objects disposed along the surface to attach to the roller assembly as the roller assembly rolls over the spiked objects during the rotation of the roller assembly, detaching the spiked objects from the roller assembly as the spiked objects attached to the roller assembly contact the scraper due to the roller assembly rotating, and receiving the spiked objects detached from the roller assembly by the scraper into a collection tray. In embodiments, collecting spiked objects disposed along the surface may be performed by the cooperative operation of a roller assembly (e.g., roller assembly 110 in FIG. 1), as well as other components of a spiked object collection device (e.g., spiked object collection device 100 of FIG. 1). In embodiments, the roller assembly may perform operations to collect spiked objects disposed along the surface according to operations and functionality as described above with reference to roller assembly 110, and as illustrated in FIGS. 1-6B.

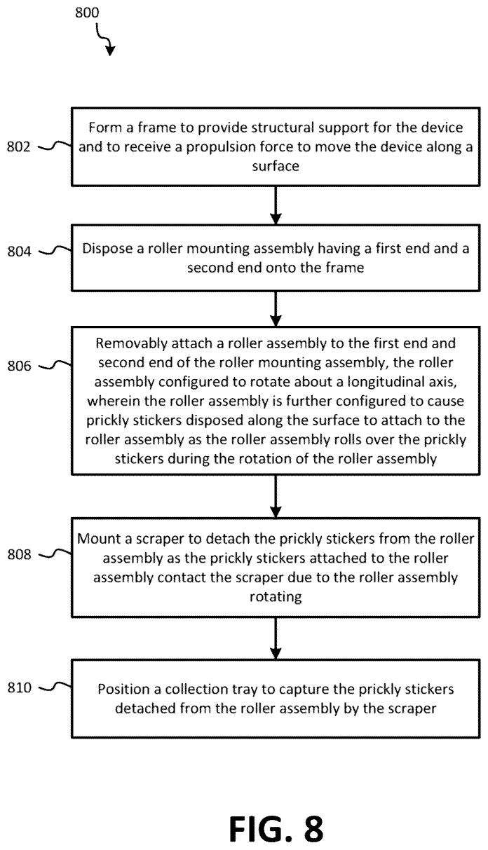

FIG. 8 shows an exemplary flow diagram of operations for manufacturing a device configured with functionality to collect spiked objects from a surface in accordance with embodiments of the present disclosure. For example, the steps illustrated in the example blocks shown in FIG. 8 may be performed to manufacture spiked object collection device 100 of FIG. 1 according to embodiments herein.

At block 502, a frame (e.g., frame 150 in FIG. 1) is formed to provide structural support for the device and to receive a propulsion force to move the device along a surface, such as illustrated in FIGS. 1-2B and 4-6B. In embodiments, forming the frame to receive the propulsion force to move the device along the surface may include configuring the frame to include a connector (e.g., vehicle connector 164 of FIGS. 6A and 6B) configured to attach the frame to a vehicle (e.g., wherein the vehicle provides the propulsion force to move the device along the surface), and/or a handle (e.g., handle 162 of FIG. 5) configured to enable a user to push against the frame (e.g., wherein the pushing by the user provides the propulsion force to move the device along the surface).

At block 804, a roller mounting assembly frame (e.g., roller mounting assembly 140 in FIG. 1) having a first end (e.g., second end 114 in FIG. 2A) and a second end (e.g., first end 112 in FIG. 2A) is disposed onto the frame. In embodiments, the roller mounting assembly may include a latch assembly. The latch assembly may be configured to enable the roller assembly to be removed from the frame. In embodiments, the latch assembly may include a latch (e.g., latch 230) disposed at the first end of the roller mounting assembly and configured to engage a first end of the roller assembly. The latch may be configured to keep the first end of the roller assembly engaged with the first end of the roller mounting assembly. In embodiments, the latch assembly may include a hinge (e.g., hinge 220 of FIG. 2A) disposed at the second end of the roller mounting assembly and configured to engage a second end of the roller assembly. The hinge may be configured to allow the second end of the roller assembly to be separated from the second end of the roller mounting assembly while the first end of the roller assembly is engaged with the first end of the roller mounting assembly.

At block 806, a roller assembly (e.g., roller assembly 110 in FIG. 1) is removably attached to the first end and second end of the roller mounting assembly. In embodiments, the roller assembly may be configured to rotate about a longitudinal axis, and may be further configured to cause spiked objects disposed along the surface to attach to the roller assembly as the roller assembly rolls over the spiked objects during the rotation of the roller assembly. In embodiments, the roller assembly may include a cylindrical drum and a sleeve configured to be laid over an outer surface of the cylindrical drum. In embodiments, the sleeve may be configured to be removable from the cylindrical drum to enable replacement of the sleeve from the roller assembly, and may be made of a material configured to enable the pricky stickers to stick to the sleeve. In embodiments, the roller assembly may further include a soft layer disposed between the cylindrical drum and the sleeve configured to provide compliance as the roller assembly rolls over the spiked objects to facilitate the spiked objects attaching to the sleeve.

At block 808, a scraper (e.g., scraper 120 in FIG. 1) is disposed to detach the spiked objects from the roller assembly as the spiked objects attached to the roller assembly contact the scraper due to the roller assembly rotating. At block 810, a collection tray (e.g., collection tray 130 in FIG. 1) is positioned to capture the spiked objects detached from the roller assembly by the scraper.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

Moreover, the description in this patent document should not be read as implying that any particular element, step, or function can be an essential or critical element that must be included in the claim scope. Also, none of the claims can be intended to invoke 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” “processing device,” or “controller” within a claim can be understood and intended to refer to structures known to those skilled in the relevant art, as further modified or enhanced by the features of the claims themselves, and can be not intended to invoke 35 U.S.C. § 112(f). Even under the broadest reasonable interpretation, in light of this paragraph of this specification, the claims are not intended to invoke 35 U.S.C. § 112(f) absent the specific language described above.

The disclosure may be embodied in other specific forms without departing from the spirit or essential characteristics thereof. For example, each of the new structures described herein, may be modified to suit particular local variations or requirements while retaining their basic configurations or structural relationships with each other or while performing the same or similar functions described herein. The present embodiments are therefore to be considered in all respects as illustrative and not restrictive. Accordingly, the scope of the disclosures can be established by the appended claims rather than by the foregoing description. All changes which come within the meaning and range of equivalency of the claims are therefore intended to be embraced therein. Further, the individual elements of the claims are not well-understood, routine, or conventional. Instead, the claims are directed to the unconventional inventive concept described in the specification.

What is claimed is:

1. A device for removing and collecting spiked objects from a surface, comprising:
a frame configured to provide structural support for the device and to receive a propulsion force to move the device along a surface, wherein the frame includes a roller mounting assembly having a first end and a second end;
a roller assembly removably attached to the first end and second end of the roller mounting assembly and configured to rotate about a longitudinal axis, wherein the roller assembly is further configured to cause spiked objects disposed along the surface to attach to the roller assembly as the roller assembly rolls over the spiked objects during the rotation of the roller assembly;
a scraper configured to detach the spiked objects from the roller assembly as the spiked objects attached to the roller assembly contact the scraper due to the roller assembly rotating; and
a collection tray configured to capture the spiked objects detached from the roller assembly by the scraper.

2. The device of claim 1, wherein the configuration of the frame to receive the propulsion force to move the device along the surface includes configuration of the frame to include one or more of:
a connector configured to attach the frame to a vehicle, wherein the vehicle provides the propulsion force to move the device along the surface; and
a handle configured to enable a user to push against the frame, wherein the pushing by the user provides the propulsion force to move the device along the surface.

3. The device of claim 1, wherein the roller mounting assembly includes a latch assembly to enable the roller assembly to be removed from the frame.

4. The device of claim 3, wherein the latch assembly includes:
a latch disposed at the first end of the roller mounting assembly and configured to engage a first end of the roller assembly, wherein the latch is configured to keep the first end of the roller assembly engaged with the first end of the roller mounting assembly; and
a hinge disposed at the second end of the roller mounting assembly and configured to engage a second end of the roller assembly, wherein the hinge is configured to allow the first end of the roller assembly to be separated from the first end of the roller mounting assembly while the second end of the roller assembly is engaged with the second end of the roller mounting assembly.

5. The device of claim 1, wherein the roller assembly includes:
a cylindrical drum; and
a sleeve configured to be laid over an outer surface of the cylindrical drum.

6. The device of claim 5, wherein the sleeve is configured to be removable from the cylindrical drum to enable replacement of the sleeve from the roller assembly.

7. The device of claim 5, wherein the sleeve is made of a material configured to enable the pricky stickers to stick to the sleeve.

8. The device of claim 5, wherein the roller assembly further includes a soft layer disposed between the cylindrical drum and the sleeve configured to provide compliance as the roller assembly rolls over the spiked objects to facilitate the spiked objects attaching to the sleeve.

9. A method of collecting spiked objects from a surface, comprising:
positioning a collection device over the surface such that a roller assembly of the collection device is in contact with the surface, the roller assembly configured to rotate about a longitudinal axis over the surface;
applying a propulsion force against a frame of the collection device, wherein applying the propulsion force against the frame of the collection device causes the roller assembly to rotate about the longitudinal axis and to roll over the surface; and
collecting spiked objects disposed along the surface, wherein collecting the spiked objects disposed along the surface includes:
causing the spiked objects disposed along the surface to attach to the roller assembly as the roller assembly rolls over the spiked objects during the rotation of the roller assembly;
detaching the spiked objects from the roller assembly as the spiked objects attached to the roller assembly contact the scraper due to the roller assembly rotating; and
receiving the spiked objects detached from the roller assembly by the scraper into a collection tray.

10. The method of claim 9, further comprising:
removing a first end of the roller assembly from a roller mounting assembly of the frame by disengaging a latch.

11. The method of claim 10, wherein disengaging the latch includes:
disengaging the latch disposed at a first end of the roller mounting assembly, the latch configured to engage the first end of the roller assembly, wherein the latch is configured to keep the first end of the roller assembly engaged with the first end of the roller mounting assembly; and
pivoting the roller assembly about a hinge disposed at a second end of the roller mounting assembly, the hinge configured to engage a second end of the roller assembly, wherein the hinge is configured to allow the first end of the roller assembly to be separated from the first end of the roller mounting assembly while the second end of the roller assembly is engaged with the second end of the roller mounting assembly.

12. The method of claim 11, further comprising:
removing a sleeve from the roller assembly after the first end of the roller assembly is removed from the roller mounting assembly, the sleeve configured to cause the spiked objects disposed along the surface to attach to the sleeve of the roller assembly as the roller assembly rolls over the spiked objects during the rotation of the roller assembly.

13. A method of manufacturing a device for collecting spiked objects from a surface, comprising:
forming a frame to provide structural support for the device and to receive a propulsion force to move the device along a surface;
disposing a roller mounting assembly having a first end and a second end onto the frame;
removably attaching a roller assembly to the first end and second end of the roller mounting assembly, the roller assembly configured to rotate about a longitudinal axis, wherein the roller assembly is further configured to cause spiked objects disposed along the surface to attach to the roller assembly as the roller assembly rolls over the spiked objects during the rotation of the roller assembly;
mounting a scraper to detach the spiked objects from the roller assembly as the spiked objects attached to the roller assembly contact the scraper due to the roller assembly rotating; and
positioning a collection tray to capture the spiked objects detached from the roller assembly by the scraper.

14. The method of claim 13, wherein forming the frame to receive the propulsion force to move the device along the surface includes configuring the frame to include one or more of:
a connector configured to attach the frame to a vehicle, wherein the vehicle provides the propulsion force to move the device along the surface; and
a handle configured to enable a user to push against the frame, wherein the pushing by the user provides the propulsion force to move the device along the surface.

15. The method of claim 13, further including a latch assembly into the roller mounting assembly to enable the roller assembly to be removed from the frame.

16. The method of claim 15, wherein the latch assembly includes:
a latch disposed at the first end of the roller mounting assembly and configured to engage a first end of the roller assembly, wherein the latch is configured to keep the first end of the roller assembly engaged with the first end of the roller mounting assembly; and
a hinge disposed at the second end of the roller mounting assembly and configured to engage a second end of the roller assembly, wherein the hinge is configured to allow the second end of the roller assembly to be separated from the second end of the roller mounting assembly while the first end of the roller assembly is engaged with the first end of the roller mounting assembly.

17. The method of claim 13, wherein the roller assembly includes:
a cylindrical drum; and
a sleeve configured to be laid over an outer surface of the cylindrical drum.

18. The method of claim 17, wherein the sleeve is configured to be removable from the cylindrical drum to enable replacement of the sleeve from the roller assembly.

19. The method of claim 17, wherein the sleeve is made of a material configured to enable the pricky stickers to stick to the sleeve.

20. The method of claim 17, wherein the roller assembly further includes a soft layer disposed between the cylindrical drum and the sleeve configured to provide compliance as the roller assembly rolls over the spiked objects to facilitate the spiked objects attaching to the sleeve.
